(19) United States
(12) Patent Application Publication
(10) Pub. No.: US 2026/0348521 A1
(43) Pub. Date: Nov. 5, 2026

(54) Safety Shield For a Power Take Off

(71) Applicant: Amanda Courtney Casey, Marks, MS (US)

(72) Inventor: Amanda Courtney Casey, Marks, MS (US)

(21) Appl. No.: 19/664,736

(22) Filed: Apr. 30, 2026

Related U.S. Application Data
(60) Provisional application No. 63/797,500, filed on Apr. 30, 2025.

(51) Int. Cl. F16P 1/02; B60K 17/28

(52) U.S. Cl. CPC F16P 1/02; B60K 17/28

(57) ABSTRACT

A removable safety cover assembly for a power take off PTO comprising an elongated screen portion having an input end and an output end, a top side screen portion and an opposing bottom side. The bottom side has a lengthwise opening. First and second side screen portions depend downward from the top side screen portion to the open bottom side. The first and second side screens are spaced apart to form an interior compartment in the screen portion, the interior compartment sized to receive the PTO and the drive shaft attached to said PTO through the bottom side. The screen portion has at least four belly bands. In embodiments, belly bands include a releasable connector.

### CROSS-REFERENCE TO RELATED APPLICATIONS

This application claims priority to and incorporates by reference the following applications: U.S. Provisional Application 63/797,500, filed Apr. 30, 2025.

### BACKGROUND OF THE INVENTION

The invention relates to a power take off (PTO) safety device for protecting users of PTOs from injury. A PTO is a splined drive shaft attached to a drive engine, such as a tractor or truck engine. A PTO is designed to be temporarily attached to a working implement and used to power the implement to perform a function. PTOs are commonly used to power lawn mowers, hay balers, tillers, sprayers, water pumps and many other types of equipment. PTOs are widely used in farming operations.

A PTO rotates in a clockwise direction at between about 500 to 1000 revolutions per minute (RPM). PTOs, along with attached drive shafts and universal joints, are a source of accidents and injury in farming. When the clothing or a body part of a user or a nearby person contacts the PTO, it can result in serious injury, the loss of a limb, or death.

For this reason, many efforts have been made to provide safety features for PTOs. Tractors with PTOs are typically provided with warning signs and labels. Some PTOs are pre-fitted with guards to cover rotating portions, such as a tube surrounding the PTO. Generally, such covers shield the majority of the PTO shaft. However, the shields are subject to wear and tear and may also malfunction. Sometimes the shields themselves become entangled with the rotating PTO shaft. In other instances, the shields break, exposing the PTO shaft.

Another safety option is to provide a power cut off switch fitted to an attachment or machinery which enables the power supply to the PTO shaft to be cut off. However, such switches add complexity and a user may not be able to reach the switch in an emergency, especially if the user has been injured by the PTO.

Shear bolts or pins can be used to secure PTO-driven implements to the PTO, such that the bolts or pins break off under excessive loads or obstructions, preventing damage to the PTO system and reducing the risk of injury.

Another option is a temporary removable cover for the drive shaft that is attached to the PTO. However, such removable covers can be cumbersome and time consuming to attach, resulting in failure to use the devices. Additionally, such covers are under a lot of stress and therefore tend to break or require repairs. In order for a removable cover to be effective over time, the cover must be easy to attach, easy to remove, safe, durable, and easy to repair.

Removable screen covers have been devised for PTOs. Screen covers can break down during use, resulting in an increased risk of exposure to the PTO shaft. Devices with three retention bands can experience breakage of bands during use, exposing the rotating shaft and putting users in danger. The current invention an improved screen cover for PTO shafts.

### SUMMARY OF THE INVENTION

It is an object of the invention to improve the safety of use of PTO shafts.

It is another object of the invention to provide a more durable and fail-safe safety mechanism for PTO shafts.

It is another object of the invention to provide a safety shield that is easy and economical to use.

The foregoing objectives are achieved by providing a safety shield having the features described herein.

The invention comprises a removable safety cover assembly for a power take off PTO shaft of a power source such as a tractor. The PTO shaft is attached to a drive shaft of an implement. The removable safety cover assembly comprises an elongated screen portion. The elongated screen portion comprises an input end and an output end, a top side screen portion and an opposing bottom side. The bottom side has a lengthwise opening sized and configured to allow the PTO and the attached drive shaft to be received within the safety cover assembly.

A first side screen portion depends downward from the top side screen portion to the open bottom side. A second side screen portion depends downward from the top side screen portion to the open bottom side. The first and second side screens are spaced apart to form an interior compartment in the screen portion, the interior compartment sized to receive the PTO and the drive shaft attached to said PTO through the bottom side.

The input end of the screen portion has an input connector thereon for selectively connecting the safety cover assembly to the power source. The output end of the screen portion has an input connector thereon for selectively connecting the safety cover assembly to the working implement.

The screen portion is provided with at least four belly bands. Each belly band comprises a lengthwise portion extending between a first end and a second end, the lengthwise portion of the belly band sized to span the opening extending between the first side screen portion and the second side screen portion.

Each of the belly bands is removably connected to the screen portion between a bottom of the first side screen and a bottom of the second side screen. Each of the belly bands has a first connector for selectively connecting the first end of the belly band to the first side screen portion and a second connector for selectively connecting the second end of the belly band to the second side screen portion, to thereby partially enclose the lengthwise opening of the bottom side to thereby assist in retaining said PTO within the screen portion.

In embodiments, at least one of the belly bands can be provided with a releasable connector thereon for selectively opening and closing the belly band, the releasable connector being sufficiently strong to remain in a closed configuration during use of the PTO. Two, three, or all four belly bands can be provided with a releasable connector. The releasable connector allows for easy opening of the associated belly band 100, facilitating maintenance.

In embodiments, the releasable connector is located on the lengthwise portion of the belly band. In embodiments, the releaseable connector is located adjacent the first end or second end of the belly band.

In embodiments, the releasable connector is a buckle. Various types of buckles can be used, provided that the buckle is sufficiently strong and does not open during operation. In embodiments, the releasable connector is a side-release buckle. A side-release buckle is easy to open simply by depressing opposing side tabs. The releasable connector can be a snap-closed side-release buckle, thus facilitating reclosure of the buckle.

In embodiments, a plurality of the belly bands have a releasable connector. In other embodiments, each of the belly bands has a releasable connector.

Methods of using the device are provided.

The foregoing and other objects, features, aspects and advantages of the invention will become more apparent from the following detailed description of the invention when considered in conjunction with the accompanying drawings.

### BRIEF DESCRIPTION OF DRAWINGS

FIG. 1 shows a front side perspective view of a safety cover assembly according to the invention.

FIG. 2 shows a side perspective view of a safety cover assembly according to the invention.

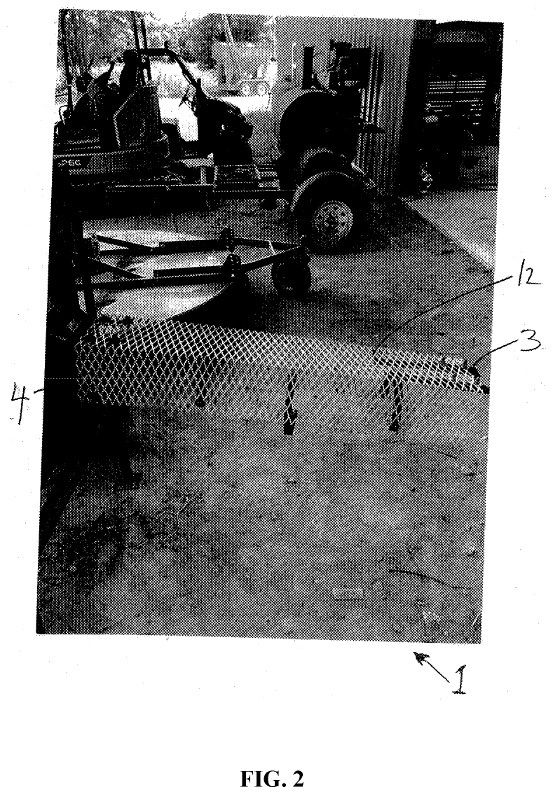

FIG. 3 shows a side perspective view of a safety cover assembly according to the invention, featuring a plurality of belly bands.

FIG. 4 shows a side perspective view of details of a safety cover assembly according to the invention affixed to a working implement.

FIG. 5 shows a cross-section view of a screen portion and a belly band.

FIG. 6 shows a cross-section view of a screen portion and a quick-release belly band.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

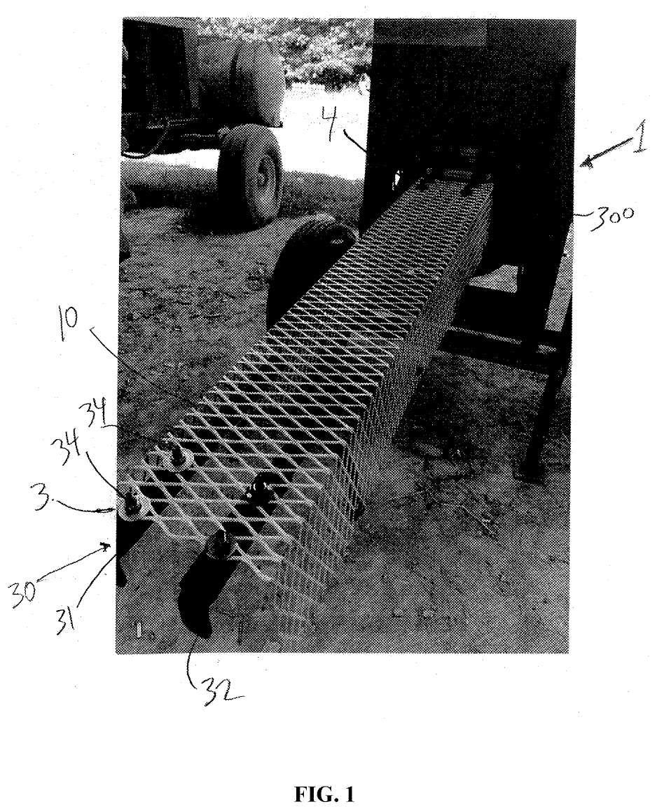

As shown in FIG. 1, the safety cover assembly 1 for a PTO 200 is a generally lengthwise structure configured to attach to a PTO source 210, such as a tractor, and a working device 300, such as a drive shaft 320 of a farm implement 300. The safety cover assembly 1 has an input side 3 for receiving a PTO 200 and an output side 4 for connecting the PTO 200 to an external machinery 300.

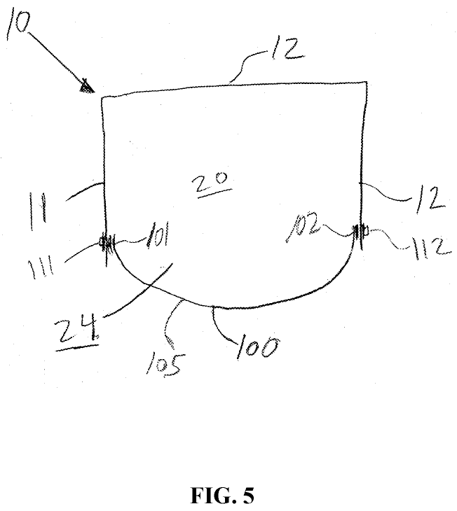

As shown in FIG. 1, the safety cover assembly 1 includes a screen portion 10 extending along the length of the device. As shown in the cross-section view of FIG. 5, the screen portion 10 includes a top screen portion 16, a first side screen portion 11, and a second side screen portion 12, and an open lower side 20. An opening 21 extends between first side screen portion 11 and second side screen portion 12.

The safety cover comprises a long, protective screen 10 with an input end 2 that attaches to the power source 210 and an output end 3 that connects to the implement 300. The screen has a top section 16 and two side sections 11, 12 that extend downward, leaving an open bottom 22 along its length. This open bottom 24 allows the PTO shaft 200 and the attached drive shaft 320 to be placed inside the cover.

As indicated in FIG. 5, the screen portion 10 forms an interior compartment 20 that selectively houses the PTO shaft and the drive shaft.

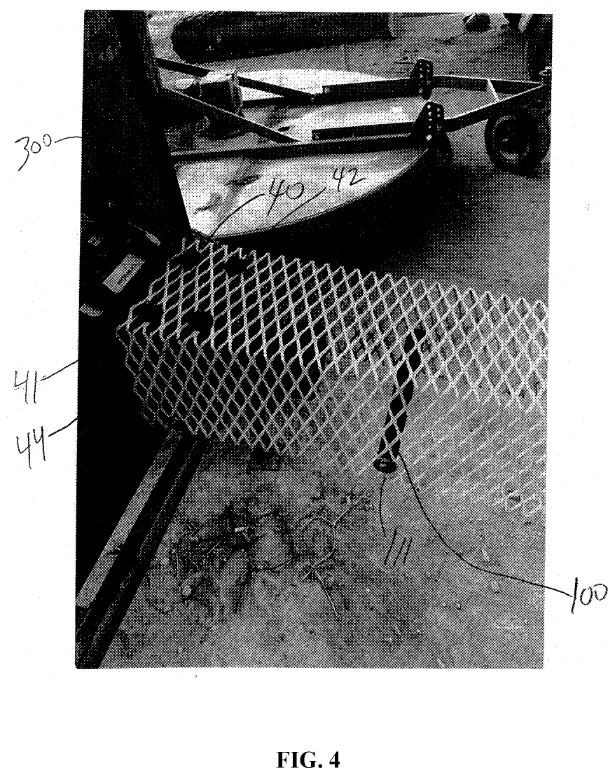

FIGS. 1 and 4 provide details of acceptable connectors. In FIG. 1, an input connector 30 on the input side 3 is shown. The connector comprises a first bar 31 and a second bar 32. The bars are connected to the top side 16 of the screen 10 by connections 34, such as by screws and bolts. The first and second bars 32 are attached to an implement having a PTO, such as a tractor, in a manner known to those of skill in the art. In FIG. 4, a output connector on the output side 4 is shown. The output connector 40 comprises a first bar 41 and a second bar 42. The bars are connected to the top side 16 of the screen 10 by connections 44, such as by screws and bolts. The first and second bars 41, 42 are attached to the working implement 300, in a manner known to those of skill in the art.

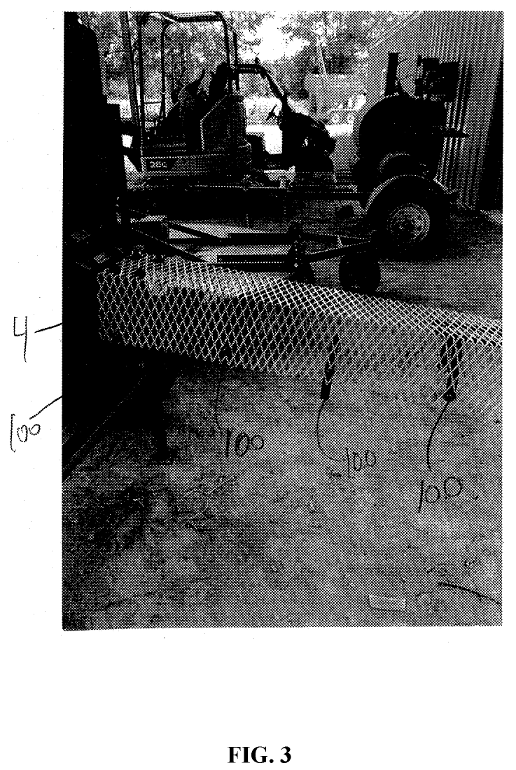

As shown in FIG. 3, to assist with keeping the drive shaft securely enclosed in the interior compartment 20, the device includes four belly bands 100. As shown in FIG. 5, each belly band has a long middle section 105 that spans the open bottom 24, with one end 101 of the belly band 100 connecting to the first side 11 and the other end 102 connecting to the second side 12 of the screen portion 10. This feature promotes safety by preventing accidental contact with the spinning PTO shaft while allowing for easy installation and removal of the device 1. While more than four belly bands 100 could be used, it is believed that a fourth belly band significantly enhances protection for users and reduces the risk of failure without adding undue complexity and cost. For example, while it is possible that multiple belly bands can break under stress such as in an accident, it is highly unlikely that all four bands will break.

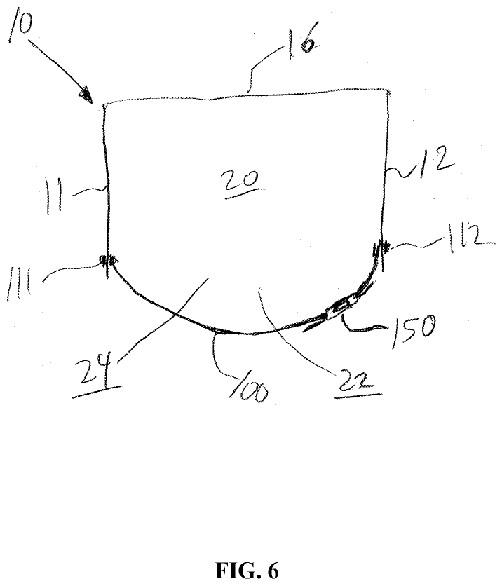

As shown in FIG. 6, in embodiments, at least one of the belly bands 100 can be provided with a releasable connector 150 thereon for selectively opening and closing the belly band, the releasable connector 150 being sufficiently strong to remain in a closed configuration during use of the PTO. Two, three, or all four belly bands can be provided with a releasable connector 150. The releasable connector 150 allows for easy opening of the associated belly band 100, facilitating maintenance.

As shown in FIG. 6, the releasable connector 150 is located on the lengthwise portion 105 of the belly band 100. In embodiments, the releaseable connector 150 is located adjacent the first end 101 or second end 102 of the belly band 100.

In embodiments, the releasable connector 150 is a buckle 150, as shown in FIG. 6. Various types of buckles can be used, provided that the buckle 150 is sufficiently strong and does not open during operation. In the embodiment of FIG. 6, the releasable connector 150 is a side-release buckle. A side-release buckle is easy to open simply by depressing opposing side tabs. The releasable connector 150 can be a snap-closed side-release buckle, thus facilitating reclosure of the buckle 150.

In embodiments, a plurality of the belly bands 100 have a releasable connector 150. In other embodiments, each of the belly bands 100 has a releasable connector 150.

Prior embodiments used three belly bands 100. The addition of a fourth belly band 100 provides significantly improved safety. Belly bands 100 can break during use, exposing the user to potential danger and injury. With the addition of a fourth belly band 100, there is a very high likelihood that at least three belly bands 100 will remain unbroken and in a functional state during use, minimizing the risk of injury.

The safety cover 1 is sized and configured to cover the PTO of a drive shaft.

The screen portion 10 of the safety cover 1 can be formed of 9 gauge mesh. Other gauges can be used but 9 gauge is an efficient and safe material that can withstand heat and intense wear and tear.

The safety cover 1 is preferably about 48 inches long, although other lengths can be used. 48 inches is ideal for most applications.

The safety cover 1 is durable and is designed to be reused for many years of use, although it may be necessary to replace components, such as the belly bands 100. One of the advantages of the invention is the open lower end 22 and the ability to replace belly bands 100 as they wear out.

The safety cover 1 or the screen portion 10 of the safety cover can be painted a bright color, such as safety yellow. The motor mounts, sliders, and belly bands 100 are typically a glossy black.

In embodiments, the safety cover 1 is sized and configured to fit any type of PTO and to serve as a universal piece of equipment.

### METHODS OF USE

Methods of use will now be described. The shaft 320 of the implement 300 is attached to the PTO shaft 200 of the power source, such as a tractor. The safety cover assembly 1 is positioned over the PTO shaft 200 so that the shaft is enclosed within the interior compartment 20 of the screen portion 10. The input end 2 is securely connected to the power source 210 and the output end 3 is properly attached to the implement 300.

The first and second connectors 111, 112 are used to fasten the belly bands 100 across the bottom opening 24 to enclose the PTO shaft. Verify that all belly bands 100 are securely attached using their respective connectors 111, 112 to prevent accidental exposure to the moving shaft.

In most cases, the safety cover 1 does not need to be removed for routine servicing of the drive shaft 320. However, if removal is necessary, individual belly bands 100 can be detached as needed to provide access to the PTO shaft without fully removing the cover. Further, if releasable connectors 150 are used, the releaseable connectors 150 can be used to temporarily open the belly bands 100 as needed.

If complete removal is required, unfasten the belly bands 100 and detach the safety cover assembly 1 from the power source 210 and implement 300. Once maintenance is complete, reinstall the cover by following the same steps in reverse.

By following these steps, the safety cover assembly 1 helps protect users from accidental contact with the rotating PTO shaft 200 while still allowing for easy maintenance and adjustments.

Although the present invention has been described in terms of specific embodiments, it is anticipated that alterations and modifications thereof will no doubt become apparent to those skilled in the art. It is therefore intended that the following claims be interpreted as covering all alterations and modifications that fall within the true spirit and scope of the invention.

What is claimed is:

1. A removable safety cover assembly for a power take off PTO shaft of a power source such as a tractor, the PTO shaft attached to a drive shaft of an implement, the removable safety cover assembly comprising:
an elongated screen portion, the elongated screen portion comprising
an input end and an output end,
a top side screen portion and an opposing bottom side, the bottom side having a lengthwise opening sized and configured to allow said PTO and said attached drive shaft to be received within the safety cover assembly,
a first side screen portion depending downward from the top side screen portion to the open bottom side,
a second side screen portion depending downward from the top side screen portion to the open bottom side,
the first and second side screens spaced apart to form an interior compartment in the screen portion, the interior compartment sized to receive said PTO and said drive shaft attached to said PTO through the bottom side,
the input end 2 of the screen portion having an input connector thereon for selectively connecting the safety cover assembly to the power source,
the output end 3 of the screen portion having an input connector thereon for selectively connecting the safety cover assembly to the working implement,
at least four belly bands, each belly band comprising:
a lengthwise portion extending between a first end and a second end, the lengthwise portion of the belly band sized to span the opening extending between the first side screen portion and the second side screen portion,
each of the belly bands removably connected to the screen portion between a bottom of the first side screen and a bottom of the second side screen,
each of the belly bands having a first connector for selectively connecting the first end of the belly band to the first side screen portion and a second connector for selectively connecting the second end of the belly band to the second side screen portion, to thereby partially enclose the lengthwise opening of the bottom side to thereby assist in retaining said PTO within the screen portion.

2. A removable safety cover assembly of claim 1, further comprising at least one of the belly bands having a releasable connector thereon for selectively opening and closing the belly band, the releasable connector being sufficiently strong to remain in a closed configuration during use of the PTO.

3. A removable safety cover assembly of claim 2, wherein the releasable connector is a buckle.

4. A removable safety cover assembly of claim 3, wherein the releasable connector is a side-release buckle.

5. A removable safety cover assembly of claim 4, wherein the releasable connector is a snap-closed side-release buckle.

6. A removable safety cover assembly of claim 2, wherein a plurality of the belly bands have a releasable connector.

7. A removable safety cover assembly of claim 6, wherein each of the belly bands has a releasable connector.

8. A removable safety cover assembly of claim 2, wherein the releasable connector is located on the lengthwise portion of the belly band.

9. A removable safety cover assembly of claim 8, wherein the releaseable connector is located adjacent the first end or second end of the belly band.
